(19) United States
(12) Patent Application Publication
(10) Pub. No.: US 2014/0319330 A1
(43) Pub. Date: Oct. 30, 2014

(54) ELPASOLITE SCINTILLATOR-BASED NEUTRON DETECTOR FOR OILFIELD APPLICATIONS

(71) Applicant: SCHLUMBERGER TECHNOLOGY CORPORATION, SUGAR LAND, TX (US)

(72) Inventors: Markus Berheide, Medford, MA (US); Bradley A. Roscoe, West Chesterfield, NH (US); Jing Qian, Arlington, MA (US); Timothy Spillane, Quincy, MA (US); Irina Shestakova, Princeton, NJ (US); Olivier G. Philip, Ewing, NJ (US); Stefan Vajda, Belle Mead, NJ (US)

(21) Appl. No.: 14/352,968

(22) PCT Filed: Oct. 18, 2012
(86) PCT No.: PCT/US2012/060720

§ 371 Date: Apr. 18, 2014

Related U.S. Application Data
(60) Provisional application No. 61/550,171, filed on Oct. 21, 2011.

(51) Int. Cl. G01V 5/10; G01T 3/06

(52) U.S. Cl. CPC G01V 5/107; G01T 3/06
USPC 250/269.5; 250/269.4

(57) ABSTRACT

Embodiments described herein are directed to methods and neutron detectors for use in downhole and other oilfield applications. In particular, the neutron detector includes a scintillator formed at least partially from an elpasolite material. In a more specific embodiment, the scintillator is formed from a Cs₂LiYCl₆ (“CLYC”) material.

### TECHNICAL FIELD

This application relates generally to radiological evaluation of geologic formations in oilfield applications. More particularly, this disclosure relates to apparatuses and methods used in detecting neutrons through scintillation.

### BACKGROUND

Many common downhole applications rely on detection of thermal or epithermal neutrons. One of the most important is neutron porosity, which is part of what is known as “triple combo” and a standard for any logging tool string. Downhole tools therefore often contain a neutron source and several thermal and epithermal neutron detectors.

The strengths of sources used to create neutrons are limited due to cost and safety concerns (e.g., from material activation). In addition, chemical sources are limited in size by government regulations; whereas, the availability of electronic neutron sources, particularly in oilfield applications, are limited by reliability and thermal management. To compensate for limited neutron source strength, a common requirement for neutron detectors for oilfield applications (e.g., downhole) is high efficiency. As space within an oilfield measurement tool, or sonde, is restricted, a detector package is also limited in size (e.g., depending on application, approx. 13-76 mm diameter and 13-200 mm long), which makes the efficiency requirement more difficult to meet.

Another complication in oilfield applications is that neutron measurement tools are constantly moving. In such applications, signals should be recorded promptly without any delays from internal processes or data acquisition. For certain types of measurements employing pulsed neutron sources, the detectors should be particularly fast. An example of such a measurement is “Sigma” in which the neutron signal decay is measured on a time scale of tens of microseconds with a resolution of, for example, one microsecond. Therefore, an additional requirement for such detectors is a reasonably short time decay, which is in the microsecond range. Furthermore, the detectors should withstand rugged borehole environments, which include shock, vibration, elevated pressures and a range of temperatures from about −40° C. to about 200° C. The number of requirements, such as those mentioned above, has traditionally left only a small number of choices available for neutron detection.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Illustrative embodiments of the present disclosure are directed to borehole logging tools. In particular, illustrative embodiments are directed to a neutron detector for use in downhole and other oilfield applications. The neutron detector includes a scintillator formed at least partially from an elpasolite material. In a more specific embodiment of the present disclosure, the scintillator is formed from a Cerium doped Cs₂LiYCl₆ (“CLYC”) material. Ce-doped CLYC maintains good resolution at high temperatures over 50° C. and up to at least 175° C. and shows only limited loss of resolution up to 200° C. This property is particularly advantageous in downhole applications in which instruments are subject to elevated pressures and temperatures. In contrast, other known scintillator-based detectors, for example, such as LiI:Eu or Li-glass, suffer from temperature degradation. In various embodiments, doped CLYC (e.g., Ce-doped) shows significantly different detector responses to neutrons and gamma rays even at high temperatures. A processor can be programmed to suppress the counts due to gamma rays based upon pulse shape discrimination.

Illustrative embodiments of the present disclosure are directed to a method for detecting neutrons. The method includes positioning a scintillator that includes an elpasolite material in a well borehole. Neutrons are released into a formation proximate to a region of the well borehole. The scintillator emits luminescence in response to interaction with neutrons returned from the formation. The method also includes detecting luminescence from the scintillator. The luminescence from the scintillator is converted to an electrical signal.

### BRIEF DESCRIPTION OF THE DRAWINGS

Further features and advantages will become more readily apparent from the following detailed description when taken in conjunction with the accompanying drawings:

FIG. 1 shows, in partial cross section, a deployed well-bore logging system having a scintillator-based neutron detector in accordance with one embodiment of the present disclosure;

FIG. 2 shows, in partial cross section, a deployed well-bore logging system having a scintillator-based neutron detector in accordance with one embodiment of the present disclosure;

FIG. 3 shows, in partial cross section, a deployed well-bore logging system having a scintillator-based neutron detector array in accordance with another embodiment of the present disclosure;

FIG. 4 shows, in partial cross section, a logging tool having a radiation-shielded scintillator-based neutron detector in accordance with another embodiment of the present disclosure;

FIG. 5 shows, in partial cross section, a logging tool having a light guide to redirect light from a scintillator slab to a photon detector in accordance with another embodiment of the present disclosure;

FIG. 6A shows a representative pulse height spectrum plot obtained from one embodiment of a cerium doped CLYC scintillator;

FIG. 6B shows a representative pulse height spectra plot obtained from one embodiment of a cerium doped CLYC scintillator at a plurality of temperatures;

FIG. 6C shows the pulse height spectra from FIG. 6B adjusted so that the centroids of the neutron peaks are aligned;

FIG. 7 shows a plot of Full Width at Half Maximum (FWHM) versus Temperature for CLYC and Li-glass;

FIG. 8 shows a plot of relative pulse-height from neutron interactions and gamma-ray interactions versus temperature for a specific example of a scintillator material determined for a common PMT configuration (the pulse-heights are normalized at room temperature);

FIG. 9 shows a discriminator region for the representative plot of the pulse height spectrum shown in FIG. 6A.

FIG. 10A shows a schematic plot of a detector responses to gamma ray interactions with a scintillator material;

FIG. 10B shows a schematic plot of a detector responses to neutron interactions with a scintillator material;

FIG. 11 shows a plot of neutron capture efficiency versus scintillator thickness for examples of different scintillator materials;

FIG. 12 shows a schematic diagram of a crystalline scintillator used in obtaining the plot shown in FIG. 11; and

FIG. 13 shows a package containing an elpasolite scintillation material in accordance with one embodiment of the present disclosure.

### DETAILED DESCRIPTION

Illustrative embodiments of the present disclosure are directed to a neutron detector for use in downhole and other oilfield applications. In particular, the neutron detector includes a scintillator formed at least partially from an elpasolite material. In a more specific embodiment of the present disclosure, the scintillator is formed from a Cs₂LiYCl₆ (“CLYC”) material. The inventors have conducted original research related to the use of CLYC neutron detectors in oilfield applications, which to the best of their knowledge has not been performed elsewhere. In doing this research, the inventors surprisingly discovered that CLYC scintillators maintain resolution at high temperatures over 50° C. and up to 175° C. and degrade only moderately up to 200° C. This performance is better than alternative scintillator materials, such as LiI:Eu or Li-glass. Another advantage that the inventors discovered is that cerium doped CLYC (“Cs₂LiYCl₆:Ce”) maintains significantly different detector responses to neutrons and gammas rays at high temperatures. Illustrative embodiments of the present disclosure make use of these significantly different responses by reducing the impact of gamma ray sensitivity on the neutron response and/or to extract gamma ray signal and neutron signal from each other.

Although cerium is identified herein as a possible activator dopant for CLYC, the present disclosure is not limited to cerium as an activator. It is also possible to dope CLYC with activators other than cerium, such as other rare earth elements. Such additional doping may improve performance of the scintillator through, for example, improved mechanical stability.

Furthermore, illustrative embodiments of the present disclosure are not limited to CLYC. There are a number of other materials from the family of elpasolites that maintain good resolution at high temperatures and/or significantly different detector responses to neutrons and gammas at high temperatures. Such materials may include, but are not limited to: Cs₂LiYBr₆ (“CLYB”), Cs₂LiLaCl₆ (“CLLC”), Cs₂LiLaBr₆ (“CLLB”), and LiYCl₆ (“LYC”). Illustrative embodiments of the present disclosure may also include blends of these listed materials. Furthermore, one or more of the constituent elements within the above listed materials can be replaced with various amounts of another similar element. In fact, such elemental variation may be desirable in some cases. For example, in some embodiments, the amount of chlorine within the scintillator material is reduced because chlorine competes with lithium for neutron capture, but releases photons in response to high energy gamma rays.

In additional or alternative embodiments, the elpasolite material (e.g., CLYC) is used in a crystalline form. In other embodiments, for example, to keep manufacturing costs down, the elpasolite material is used in a polycrystalline form.

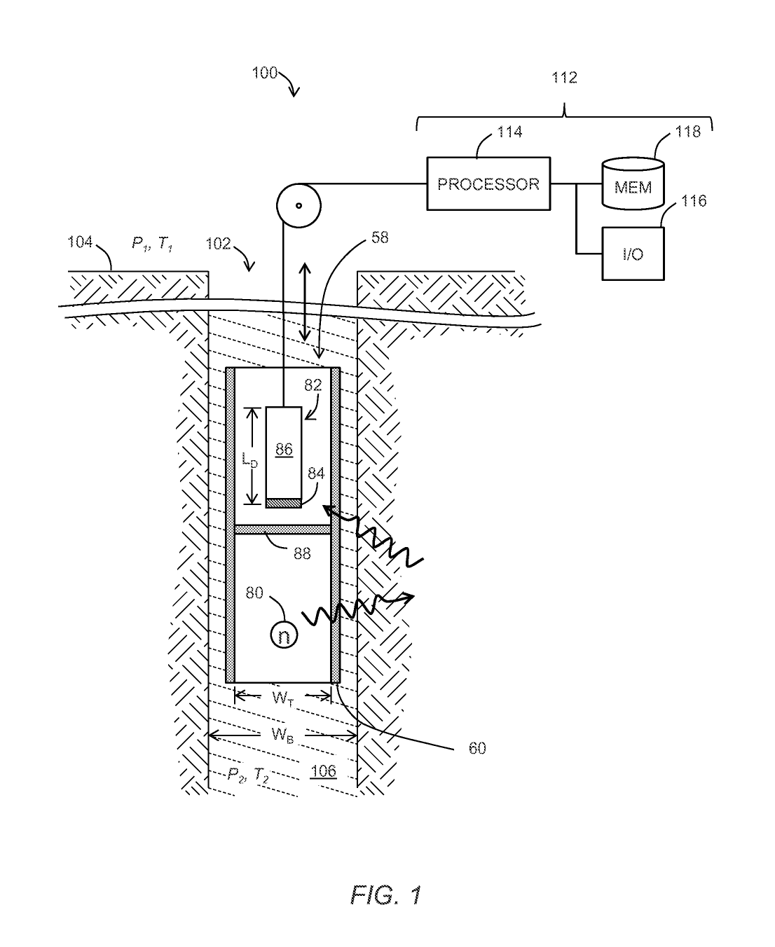

As explained above, illustrative embodiments of the present disclosure are directed to a neutron detector for use in downhole and other oilfield applications. In particular, the neutron detector includes a scintillator formed at least partially from an elpasolite material. FIG. 1 shows a cross section of a deployed well-bore logging system 100 having a scintillator-based neutron detector in accordance with one embodiment of the disclosure. A well borehole 102 is shown penetrating a surface of the earth 104. The well borehole 102 may be filled with a well fluid 106 as shown. A downhole portion 58 of the logging system 100 may include an elongated, fluid tight, hollow, body member or sonde 60, which during the logging operation, is passed longitudinally through the well borehole 102 and is sized for passage therethrough.

In the embodiment of FIG. 1, at least one radiation detector 82 is provided in the downhole sonde 60 and is separated from a neutron source 80 by a radiation shielding material 88. This illustrative example also includes surface instrumentation 112. For example, the surface instrumentation 112 includes a processor 114, an input/output device 116, and a data storage device 118. The detector 82 is configured to detect at least one of thermal neutrons (e.g., about 0.025 eV) and epithermal neutrons (e.g., between about 1 eV and about 10 keV). The detector 82 includes a scintillator 84 that includes a material exhibiting luminance when struck by incoming particles (e.g., neutrons) of a preferred energy level or range (e.g., thermal and/or epithermal neutrons). For example, in one embodiment, the scintillator includes an elpasolite material. In a more specific embodiment of the present disclosure, the scintillator includes a CLYC material doped with cerium. A CLYC material doped with cerium is available from RIVID™ in Watertown, Mass.

The scintillator 84 is positioned in optical communication with a luminescence detector 86 configured to provide a response (e.g., an electrical signal) indicative of the scintillator 84 being struck by a particle. In the illustrative embodiment of FIG. 1, a cylindrical scintillator crystal 84 is positioned adjacent to an elongated photo multiplier tube (PMT) 86. The PMT 86 is axially oriented, such that its length L_{D} is not restricted by a width of an opening W_{T} of the sonde 60. Further details of the various components are described in more detail below, with respect to various other embodiments.

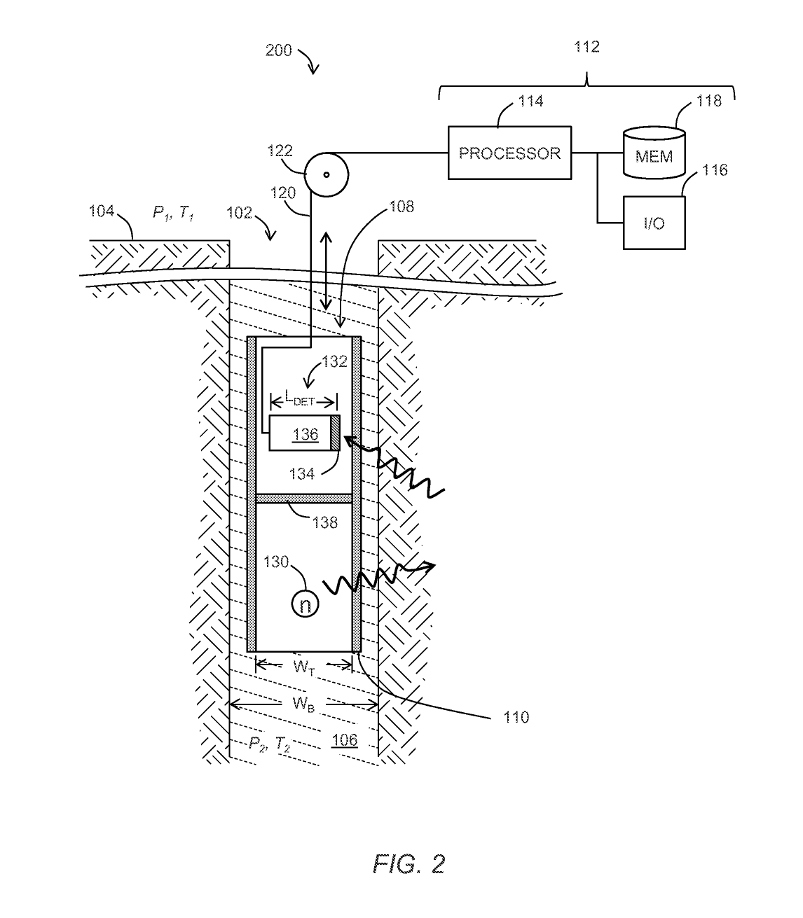

FIG. 2 shows a cross section of a deployed well-bore logging system 200 having a scintillator-based neutron detector in accordance with another embodiment of the disclosure. A well borehole 102 is shown penetrating a surface of the earth 104. The well borehole 102 may be filled with a well fluid 106. A downhole portion 108 of the logging system 200 may include an elongated, fluid tight, and hollow body member (e.g., sonde) 110, which during the logging operation, is passed longitudinally through the well borehole 102 and is sized for passage through the well borehole. The examples described herein refer to oilfield applications generally known as wireline. Use of any of the scintillator-based neutron detector arrangements and/or methods described herein are contemplated for use in any of various oilfield applications, such as techniques generally known as “wireline”, “logging-while-drilling”, and surface analysis of wellbore samples, including laboratory analysis.

As shown in FIG. 2, the well bore 102 is substantially circular in transverse cross section, having a diameter W_{B}. In the illustrative example, the sonde 110 is substantially cylindrical, having a diameter less than that of the well borehole 102 to allow for ease of passage through the well borehole. It is contemplated that in other embodiments, the sonde may take on other non-cylindrical shapes. In at least some embodiments, the relative diameters are such that some of the well fluid 106 may reside between an outer surface of the sonde 110 and an adjacent inner wall of the well borehole 102. An inner hollow of the sonde 110 in the illustrative example is substantially cylindrical, having an inner diameter W_{T}. The shape and size of the hollow portion of the sonde 110 provides physical size constraints upon instrumentation placed therein.

When positioned at a depth within the well borehole 102, the sonde 110 will experience a locally ambient temperature T₂ and pressure P₂ that will likely differ substantially from ambient conditions at the surface T₁, P₁. For example, well borehole 102 temperatures may be 100-200° C. depending upon the depth and other geological conditions. Similarly, ambient pressures may be well in excess of surface values. Such elevated temperatures and pressures place additional constraints upon the downhole portion 108 of the logging system 200.

The illustrative example also includes surface instrumentation 112. For example, the surface instrumentation includes a processor 114, an input/output device 116, and a data storage device 118. Such surface instrumentation 112 can be used in processing and/or recording electrical measurements provided by the sonde 110. A well logging cable 120 is coupled between the downhole portion 108 and the surface instrumentation 112. The well logging cable 120 passes over a sheave wheel 122 supporting the sonde 110 in the borehole 102 and in the illustrative example, also provides a communication path for electrical signals to and from the surface equipment 112 and the sonde 110. The well logging cable 120 may be of conventional armored cable design and may have one or more electrical conductors for transmitting such signals between the sonde 110 and the surface instrumentation 112.

In the example of FIG. 2, the sonde 110 contains, at its lower end, a pulsed neutron source 130. The neutron source 130 may comprise a deuterium-tritium accelerator tube which can be operated in pulsed mode to provide repetitive pulses or bursts of essentially mono-energetic neutrons (e.g., with an energy of 14 MeV neutrons). In some embodiments, a deuterium-tritium accelerator tube is capable of providing on the order of 10⁺⁸ neutrons per second. A pulsing circuit (not shown) provides electrical pulses, which are timed in a manner to cause the neutron generator 130 to repetitively emit neutron pulses of a preferred width (e.g., approximately 10 microseconds duration).

At least one scintillator-based radiation detector 132 is provided in the downhole sonde 110 and is separated from the neutron source 130 by a shielding material 138. The shielding material 138 is configured to scatter neutrons away from the tool and also to reduce secondary radiation from X-ray or gamma-rays originating near the source. The shield material 138 may include a dense material with a high atomic number, such as tungsten. In additional or alternative embodiments, the shield 138 may include a material with high neutron cross section, such as Borated rubber. In yet other illustrative embodiments, the shielding material 138 may comprise any highly hydrogenous material, such as paraffin or hydrocarbon polymer plastics, to effectively slow down and shield the detector 132 from direct neutron irradiation by the neutron source 130.

While only a single detector 132 is shown in FIG. 2, illustrative embodiments of the present disclosure include multiple detectors within the sonde 110. In one example, two detectors 132 are located on the same side of the sonde 110 relative to the neutron source 130. In another illustrative embodiment, a first detector 132 is located above the neutron source 130 and a second detector 132 is located below the neutron source. In some embodiments, the detectors 132 are equidistant from the source 130. In further illustrative embodiments, the neutron source 130 is positioned towards an upper end of the sonde 110, while any detectors 132 are positioned towards a lower end of the sonde. The relative positioning of the neutron sources 130 and detectors 132 shown in any of the embodiments described herein is merely intended by way of example.

The detector 132 as shown in FIG. 2 is configured to detect at least one of thermal neutrons (e.g., about 0.025 eV) and epithermal neutrons (e.g., between about 1 eV and about 10 k eV). This detector 132 includes a scintillator 134 fashioned from a material exhibiting luminescence when struck by incoming particles (e.g., neutrons) of a preferred energy level or range (e.g., thermal and/or epithermal neutrons). The scintillator 134 is positioned in optical communication with a luminescence detector 136 configured to provide a response (e.g., an electrical signal) indicative of the scintillator 134 being struck by a particle.

Such a detector 132 could comprise, for example, a scintillator 134 that includes an elpasolite material (e.g., CLYC), which is sensitive to neutron interaction (primarily thermal), in combination with a photon detector 136, such as a photo multiplier tube (PMT). Such scintillator detectors 132 may also be sensitive to high energy gamma radiation produced by the capture of neutrons from the neutron source 130 in earth formations surrounding the well borehole 102. However, in illustrative embodiments of the present disclosure, the pulse shape characteristics of the gamma ray interactions with the scintillator material may be distinguished from the pulse shape characteristics of neutron interactions with the scintillator material.

In more detail, the detector 132 provides electrical pulse signals representative of the number of electrons created by a single neutron event in the target energy range to which the detector is sensitive (e.g., thermal and/or epithermal neutrons) and their time distribution. The electrical signals from the detector 132 can be amplified or otherwise conditioned in an electronic conditioning circuit (e.g., an amplifier—not shown) and otherwise manipulated by other circuitry (e.g., a multiplexing mixing circuit for multiple detectors—not shown). The conditioned electrical signal can be supplied via the cable 120 conductors to additional surface circuitry (e.g., de-multiplexing or un-mixing circuits—not shown). Output signals comprise pulse signals representative of the target neutron population in the vicinity of the detector 132. The resulting pulse signals can be subjected to further processing, for example, in the processor 114. Such processing can be accomplished by digital signal processing (DSP) techniques, analog signal processing techniques, software, or some combination thereof. In one particular embodiment, the processor 114 distinguishes between the pulse shape characteristics of neutrons and the pulse shape characteristics of gamma rays using pulse shape discrimination, as further described below.

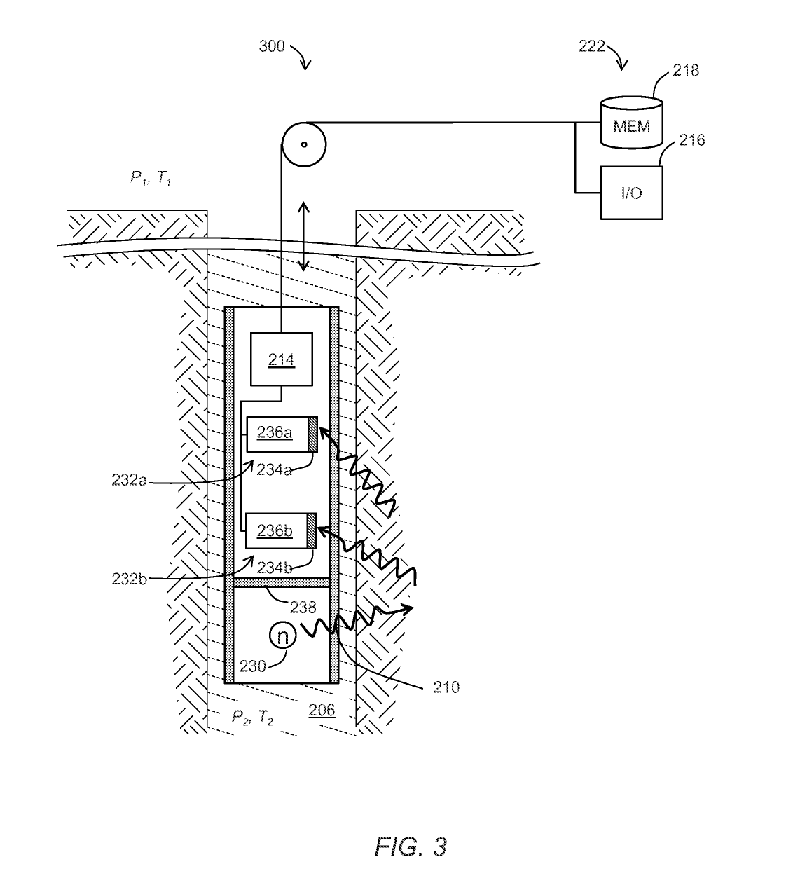

FIG. 3 shows a cross section of a deployed well-bore logging tool 300 having a scintillator-based neutron detector array in accordance with yet another embodiment of the disclosure. In this alternative embodiment, an array of two different detectors 232a, 232b (generally 232) are positioned within an inner hollow of a sonde 210. Each of the detectors 232a, 232b can be identical (e.g., both using cerium doped CLYC) and for example, measure similar neutron interactions at different locations. Alternatively or in additional embodiments, each of the detectors 232a, 232b can be different. The detectors 232 are positioned in a spaced apart relation to a neutron source 210 and separated therefrom by an energetic neutron barrier or shield 238. It is contemplated that the array may include more than two detectors 232 and that such detectors may be positioned or otherwise oriented in any of various arrangements (e.g., linearly spaced along a longitudinal tool axis, radially about a common axis, any of a variety of detector alignments, and combinations of the like).

In this illustrative example, surface equipment 222 includes an I/O device 218 and a storage device 216. A processor 214, in electrical communication between the detectors 232 and the surface equipment 222, is shown as being internal to the sonde 210. It is envisioned that various configurations with one or more of the processors 214, I/O devices 218, and storage devices 216 can be provided downhole, at the surface, or split between downhole and the surface as may be advantageous for implementation of deployed well-bore logging systems.

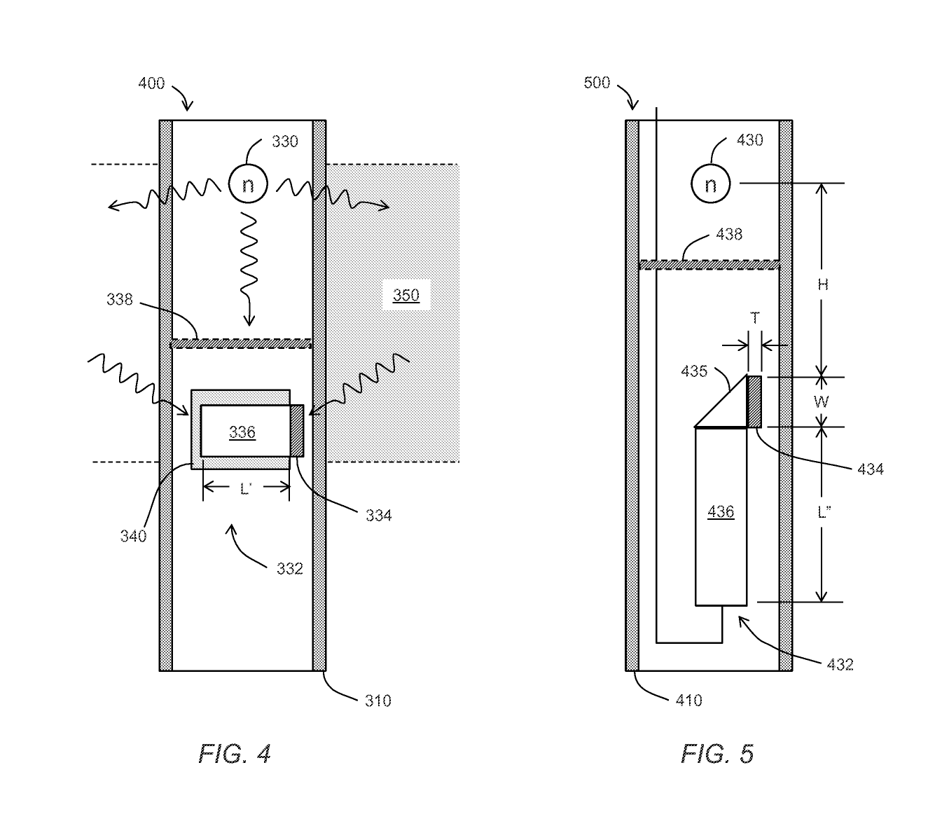

FIG. 4 shows a cross section of a logging tool having a radiation-shielded scintillator-based neutron detector in accordance with one embodiment of the disclosure. The downhole logging tool 400 includes a sonde 310 including a neutron source 330 and a neutron detector 332 separated by a radiation shield 338. The detector 332, in turn, includes at least one scintillator material 334 (e.g., CLYC) positioned to face a formation (e.g., laterally with respect to a longitudinal axis of the tool). In the illustrative example of FIG. 4, a substantially planar detector 334 (slab) is positioned with one face directed toward the lateral formation 350 (e.g., directed radially outward from a central axis). A photon detector, such as a PMT 336, is positioned adjacent to an opposite surface of the planar scintillator 334 and otherwise configured to detect photons induced within the scintillator 334 by interaction with a neutron directed from the formation. As shown, the generally elongated PMT 336 is positioned with its longitudinal axis transverse to a longitudinal axis of the sonde 310. For example, the PMT 336 is aligned along a diameter of the sonde 310. According to limited space generally available within oilfield sondes, compact PMTs are selected having dimensions commensurate with the available space. To the extent other compact photon detectors, such as semiconductor devices, can withstand the environmental conditions; other such devices can be used in combination with any of the scintillators described herein. Such semiconductor devices include photodiodes and avalanche photodiodes.

As described above, the radiation shield 338 protects or otherwise shields the detector from neutrons and secondary radiation directed from the neutron source 330. Likewise, positioning a face of the planar scintillator 334 toward the formation 350 provides preferential detection of neutrons from the formation 350 rather than from the borehole. In some embodiments, additional neutron shielding 340 can be provided to further shield the scintillator 334 and/or the PMT 336 from non-preferential neutrons. In the illustrative example of FIG. 4, such a neutron shield 340 (shown in cross section) is provided along rear and side portions of the detector 332. Such shield material can be any suitable material, in a suitable configuration (e.g., thickness) to shield or otherwise block (i.e., scatter and/or absorb) non-preferential neutrons. In such a configuration, the detector 332 is configured to maximize neutron detection from a preferred sample volume (e.g., the formation 350). In some embodiments, such additional radiation shield may be provided along an outer body of the detector 332, along an inner wall of the sonde 310, or some combination of the like.

In each of the above examples, the PMT detector 136, 236, 336 is configured in a transverse plane with respect to the sonde 110, 210, 310 and subject to dimensional limitations of the available volume. Relative short or otherwise compact PMTs can be selected to fit within diameters of the sonde 110, 210, 310. In some applications, it may be advantageous to relieve at least some of the dimensional requirements by configuring the PMT along a longitudinal axis of the sonde.

FIG. 5 shows a cross section of a logging tool 500 configured with a PMT along a longitudinal axis of the sonde. In FIG. 5, a neutron detector 432 includes an elongated photon detector (e.g., PMT 436) parallel to or otherwise coincident with a longitudinal axis of the sonde 410. The detector 432 includes a planar (slab) scintillator 434 facing laterally as in the previous examples. Such lateral orientation provides similar benefits as described above. Also shown is an optical redirecting path element 435 re-directing at least a non-trivial portion of luminescence from the lateral, planar scintillator 434 toward an input of the axial PMT 436. For example, the optical redirecting path element 435 can include one or more of an optical waveguide, a prism, an optical fiber, and the like.

It is envisioned that downhole logging tools can combine any of the various elements and features described herein and equivalents thereof. For example, multiple detectors can include one or more of axially-redirected detectors (e.g., 432), lateral detectors (e.g., 132, 232, 323), axial detectors in which a planer scintillator is substantially in a transverse plane of the sonde 110, 210, 310, 410 (not shown), and combinations of one or more of any such detectors. Likewise, one or more of the detectors may include additional shielding as shown in reference to FIG. 5. Additional shielding against gamma rays may be applied from the formation side or enclosing the whole detector.

In choosing a scintillator-based neutron detector and, more particularly, a CLYC material for a scintillator, the inventors took an approach that is contrary to what they understood to be the conventional wisdom. Those in the art recognize significant disincentives associated with scintillator-based neutron detectors. Sintillator-based neutron detectors have problems with gamma ray sensitivity. Another major disadvantage of most known scintillator-based neutron detectors is that their light output drops significantly as temperature increases. This phenomenon causes energy resolution to drop, which, in turn, reduces signal and increases statistical uncertainty. Scintillator materials previously used in the industry suffer from these and other problems. For example, ⁶Li-glass detectors suffer from (1) tailing of the neutron peak, (2) changes in temperature from variations in light yield and absorption, and (3) variations in Li-glass batches.

Another significant disincentive associated with using CLYC as a scintillator material is that CLYC is hygroscopic. This property complicates the packaging requirements for the CLYC material and also makes the material more difficult to test and use under high temperatures.

Despite the vast number of materials to choose from and the above described obstacles teaching away from their solution, the inventors pursued CLYC as a possible material for a scintillator-based neutron detector for oilfield applications and surprisingly discovered that CLYC maintains resolution at high temperatures over 50° C. and up to at least 175° C. Above 175° C., resolution degrades only moderately up to about 200° C. This performance is better than alternative scintillator materials, such as LiI:Eu or Li-glass. Another advantage that the inventors discovered is that cerium doped CLYC (“Cs₂LiYCl₆:Ce”) maintains significantly different detector responses to neutrons and gammas rays at high temperatures.

Illustrative embodiments of the present disclosure are also directed to a processor that processes an output signal that is received from a neutron detector. In accordance with various embodiments of the present disclosure, the neutron detector includes a scintillator material composed of an elpasolite material (e.g., CLYC doped with cerium). The output signals received from the neutron detector are representative of neutron and gamma rays that interact with the scintillator material. In various embodiments, the processor is the processor 114 shown in FIGS. 1 and 2. The processor is configured to distinguish the scattered neutrons from gamma rays by identifying a peak within the output signal. In various embodiments, the peak within the output signal is identified using pulse shape discrimination, which is further described below. In additional or alternative embodiments, the peak within the output signal is identified using pulse height discrimination, which is also further described below.

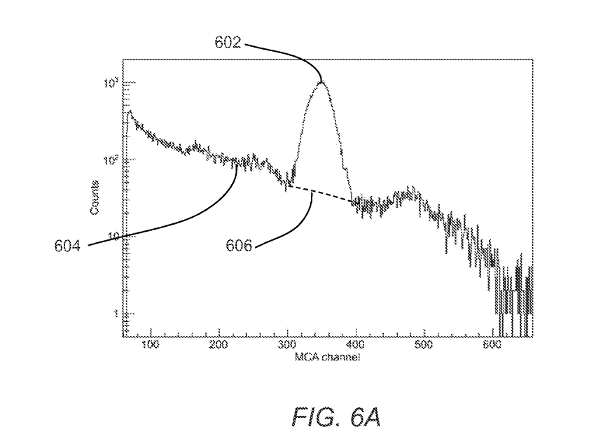

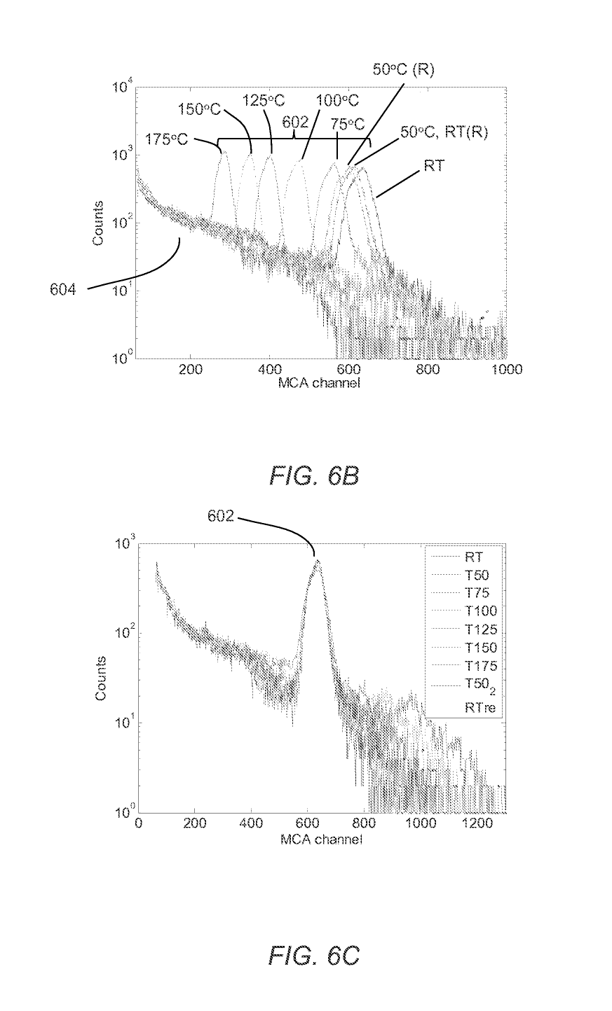

FIG. 6A shows a representative pulse height spectrum plot obtained from one embodiment of a cerium doped CLYC scintillator. The spectra were measured with an AmBe source in a cylindrical polyethylene moderator for detector temperature of 150° C. The plot includes an apparent neutron peak 602 at around channel 350, which is indicative of preferential neutron detection. The neutron peak 602 extends from a generally downward sloping baseline portion of the spectrum 604, resulting predominantly from background gamma radiation. Also shown in the plot is a linear approximation of the gamma radiation spectrum 606 in the region of the relative peak 602. Such an approximation can be derived from the respective counts at each edge of the neutron peak 602 and an exponential curve fitted through these data points.

FIG. 6B shows a representative pulse height spectra plot obtained from one embodiment of a cerium doped CLYC scintillator at a plurality of temperatures. The spectra were measured with an AmBe source in a in a cylindrical polyethylene moderator for detector temperatures ranging between room temperature to 175° C. (with recovery runs at 50° C. and room temperature). The plot includes a single neutron peak 602 for each of the measured temperatures. The peak for 175° C. is farthest to the left on the plot. The other neutron peaks 602 at 150° C., 125° C., 100° C., 75° C., 50° C. (recovery), 50° C., Room Temperature (recovery), and Room Temperature appear from left to right, respectively, on the plot. For the entire range of temperatures, the neutron peaks 602 stand out well from the gamma ray background, which is indicative of preferential neutron detection at a wide range of temperatures (e.g., room temperature to 175° C.) for the CLYC scintillator.

FIG. 6C shows an adjusted pulse height spectra obtained from one embodiment of a cerium doped CLYC scintillator. In FIG. 6C, the gain for the spectra has been adjusted to align the centroids of the neutron peaks 602. As shown in FIG. 6C, the neutron peaks 602 overlap well. This overlap indicates that the resolution of the CLYC scintillator is constant throughout the temperature range. In other words, the shape and size of the neutron peaks 602 changes little over the range of temperatures. In fact, shape and size of the neutron peaks 602 for the CLYC scintillator are maintained up to 150° C., and degrade only slightly at 175° C. The inventors of the disclosure have discovered that neutron peaks 602 for the CLYC scintillator only moderately degrade at 185° C. and at 200° C.

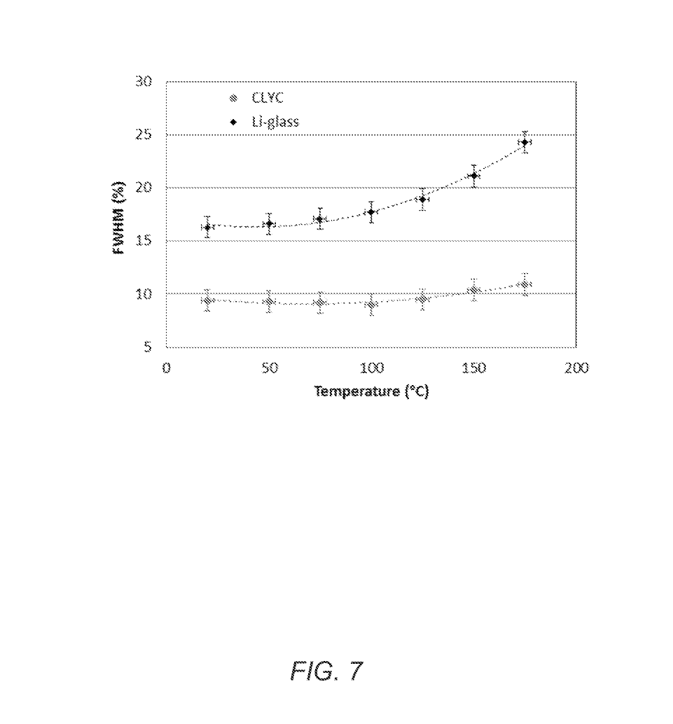

Furthermore, FIGS. 6A-6C show that the neutron peaks 602 for CLYC have relatively narrow full width at half maximum (FWHM). This characteristic of CLYC is advantageous because a narrow peak provides better resolution and provides a better estimate of counts for the neutron interaction. FIG. 7 shows a plot of FWHM versus temperature for CLYC and Li-glass. As is shown in the plot, CLYC maintains a relatively constant and narrow FWHM for the entire temperature range of the plot. This curve shows that CLYC maintains its resolution even at high temperatures. In contrast, Li-glass shows a broader FWHM at low temperatures and the FWHM increases in breadth as the temperature increases. The Li-glass curve shows that the resolution of Li-glass degrades as temperature increases.

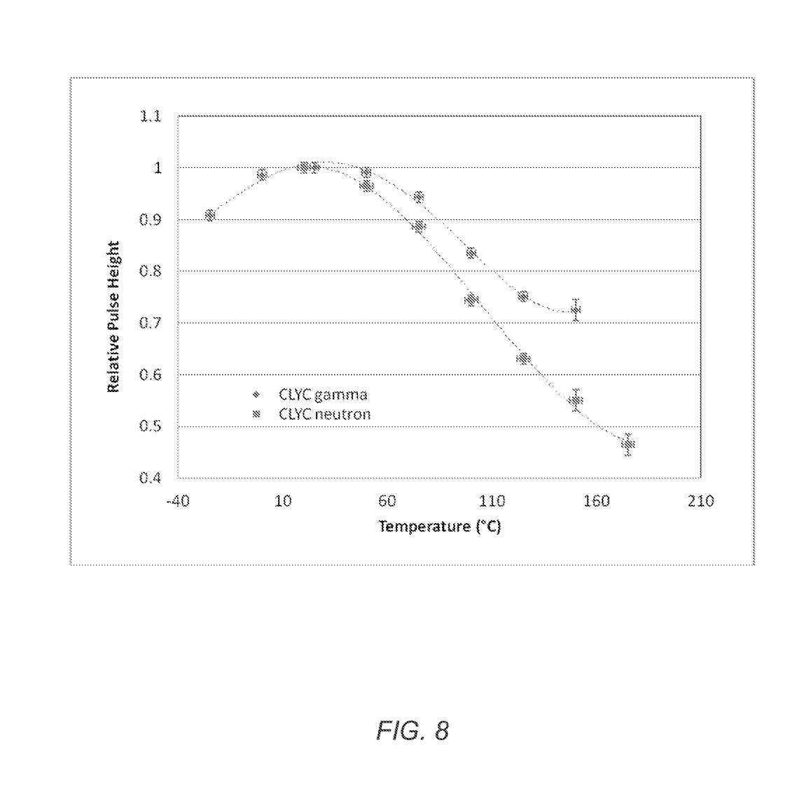

FIG. 8 shows a plot of relative pulse-height from neutron interactions and gamma-ray interactions versus temperature for a cerium doped CLYC scintillator material determined for a common PMT configuration. The plot was obtained using a rugged high-temperature PMT and the pulse-heights in this plot have been normalized to room temperature. The plot includes the effects of QE loss, crystal light loss, and PMT gain shift. The plot indicates performance of the CLYC scintillator in an actual oilfield tool. The plot shows that CLYC has different relative pulse heights for neutron and gamma interactions in the range of 60° C. to 150° C. and that both drop with temperature. Using conventional wisdom, one would also expect that the resolution of the peaks will deteriorate with temperature. However, as seen above in FIG. 7 this is not the case. The inventors recognized that this phenomenon of maintaining resolution in spite of degradation in pulse height is particularly advantageous for oilfield applications, where temperatures in certain operations (e.g., logging while drilling) commonly range between 100° C. and 175° C.

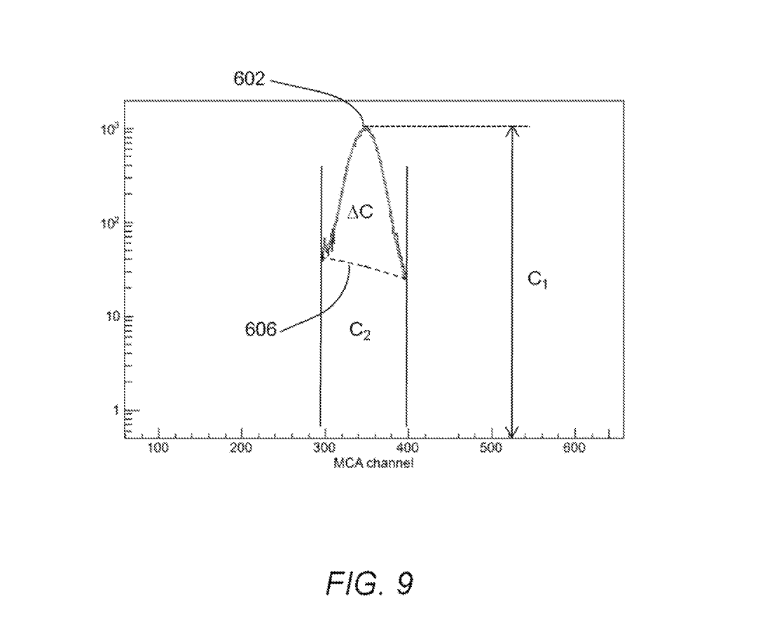

Illustrative embodiments of the present disclosure are directed to using difference in pulse heights to distinguish between neutron interactions and gamma ray interactions. In particular, pulse height discrimination (PHD) is used to distinguish between neutron interactions and gamma ray interactions with the CLYC material. To this end, a discriminator region is defined within a plot of the pulse height spectrum. FIG. 9 shows a discriminator region for the representative plot of the pulse height spectrum shown in FIG. 6A. A discriminator region is defined as the region of the spectrum including the relative peak 602. The discriminator region can be obtained by limiting results to those interactions within the relative peak. For example, in FIG. 9, the results are limited to channels between 300 and 400.

A total count (e.g., C₁) is used as an indication of all interactions (e.g., total area under the spectrum within the discriminator region). The neutron interactions can be separated from the gamma radiation interactions by subtracting a portion of the count due to the estimated gamma radiation spectrum (e.g., C₂) from the total count (e.g., C₁). The portion of the count due to the estimated gamma radiation spectrum (e.g., C₂) is estimated using an approximation (e.g. linear or exponential) of the gamma radiation spectrum 606 in the region of the relative peak 602 (e.g., the area under the linear approximation 606 within the discriminator region). The portion of the count due to neutron interactions is illustrated as ΔC (e.g., the remaining area under the spectrum within the discriminator region). A processor can be configured (e.g., programmed) to distinguish between neutron interactions and gamma ray interactions based upon the above described pulse height discrimination. In some embodiments, the processor applies a lower threshold below the onset of the neutron peak and, thus, distinguishes neutron interactions from lower energy gamma background interactions.

Pulse shape discrimination (PSD) has been used in laboratory conditions in conjunction with scintillator materials that have differences in the time decay between neutron related and gamma related interactions (e.g., liquid scintillators). The inventors have recognized that this approach has not been applied in any oilfield applications because of the unsuitability of this method for known materials, such as lithium-iodide and lithium-glass, in oilfield applications.

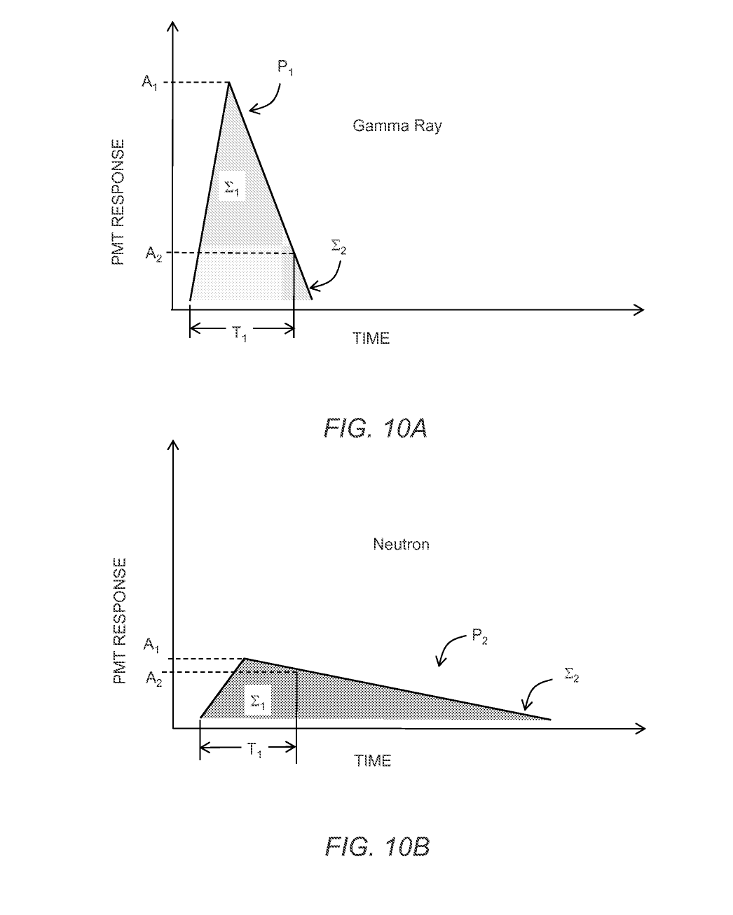

In the plots shown in FIGS. 10A and 10B, a neutron interaction and a gamma ray interaction are distinguished using pulse shape discrimination (PSD). FIG. 10A shows a plot of a representative detector's (e.g., CLYC scintillator) response to a gamma ray interaction. In the illustrative example, a first pulse shape P₁ is obtained as a detector output from the gamma ray interaction. As shown the response is intense, but short lived. FIG. 10B shows a plot of a representative detector's (e.g., CLYC scintillator) response to a neutron interaction. In the example, a second pulse shape P₂ is obtained as detector output from the neutron interaction. By comparison, the neutron response is less intense and exhibits a greater duration. In another example, when using a different scintillator material from the elpasolite family (e.g., CLLB), the gamma ray interaction may have a peak of greater duration, whereas the neutron peak has a shorter duration than the gamma ray peak. The different “shape” of the responses can be used to discriminate between the two types of interactions.

To this end, the shapes of the responses are measured and characterized by the processor (e.g., in analog and/or digital form). As illustrated in the FIGS. 10A and 10B, the first pulse P₁ (e.g., gamma ray response) has a peak response value of A₁ and a particular response value of A₂ at time T₁. Within time T₁, the pulse has a first respective area under the plot of Σ₁ and a total area under the plot of Σ₂. Similarly, the second pulse P₂ (e.g., neutron response) has a peak response value of A₁ and a particular response value of A₂ at time T₁. Within time T₁, the pulse has a first respective area under the plot of Σ₁ and a total area under the plot of Σ₂. These numerical values can be compared and used to estimate whether a detected interaction corresponds to a gamma ray interaction or a neutron interaction. One such comparison can be a simple ratio of A₁/A₂. A relatively large ratio is indicative of a gamma ray interaction, while a relatively small ratio is indicative of a neutron interaction. In another example, the comparison is made using the ratio of Σ₁/Σ₂. A relatively large ratio is indicative of a gamma ray interaction, while a relatively small ratio is indicative of a neutron interaction. A processor can be configured (e.g. programmed) to distinguish between neutron interactions and gamma ray interactions based upon the above described pulse shape discrimination. For example, well known signal processing techniques can be applied to detector output signals to otherwise differentiate between multiple different detector responses.

PHD and PSD may be combined for additional benefits. For example, if PSD is used based on an amplitude ratio as described above, a PHD may be useful to limit the range of amplitudes under consideration. This eliminates artifacts from ratios between small signals or large signals that could introduce systematic errors. In addition PSD may require more computing power and PHD may therefore be advantageous to reduce the data rate by preselecting data in the right pulse height range.

The inventors have also recognized that another advantage of CLYC as a scintillator material over Li-glass is that the composition of CLYC (in its crystalline form) is well controlled in its stoichiometry. This favorable property will result in limited sample-to-sample variations and well controlled parameters, such as thermal expansion.

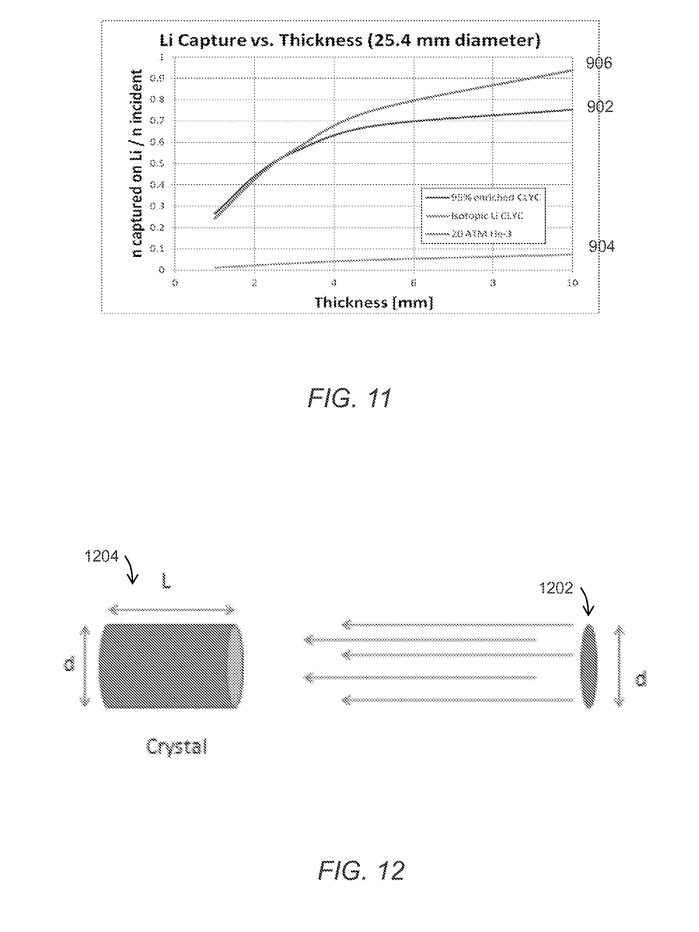

FIG. 11 shows a plot of neutron capture versus scintillator thickness for examples of different scintillator materials. Results in the illustrative example were obtained by modeling thermal neutron capture on a 25.4 mm (1 inch) diameter slice of Cs₂LiYCl₆:Ce (95% ⁶Li enriched) for different slice thicknesses 902 in comparison to CLYC doped with Li in a natural isotopic ratio 904 and an equivalent volume of ³He gas 906. The corresponding geometry is shown in FIG. 12 with a source 1202 disposed on the right-hand side and a detector 1204 on the left-hand side. The detector includes a diameter (d) and a thickness (L). Note, that 5 mm CLYC enriched in ⁶Li will stop about ⅔ of the neutrons in Li.

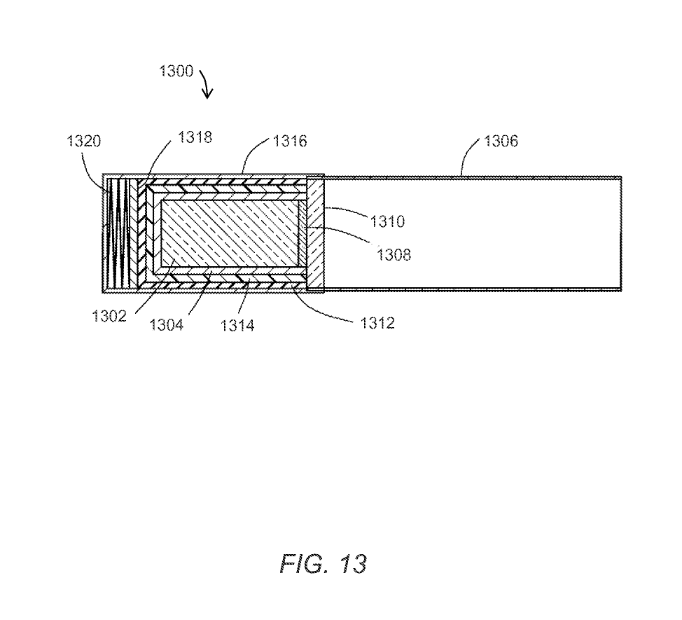

Illustrative embodiments of the present disclosure are also directed to a package for containing the elpasolite scintillator material (e.g., CLYC). The package protects the elpasolite material from exposure to borehole environments. In a particular embodiment, the package is hermetically sealed to prevent the elpasolite material from absorbing water because many elpasolite materials (e.g., CLYC) are hygroscopic. FIG. 13 shows a package 1300 containing an elpasolite scintillation material 1302 in accordance with one embodiment of the present disclosure. The package 1300 includes an elpasolite scintillation material 1302. In various embodiments, the scintillation material 1302 has a cylindrical shape and is partially surrounded by a reflector 1304 (e.g., an optically reflective material). The longitudinal end of the scintillation material 1302, closest to a photon detector 1306 (e.g., photomultiplier tube (PMT)), does not include the reflector 1304. In this manner, the reflector 1304 causes light to reflect back toward the longitudinal end of the scintillation material 1302. The configuration increases the probability that the light will be directed towards the photon detector 1306 coupled to the longitudinal end of the scintillation material 1302.

In various embodiments, the longitudinal end of the scintillation material 1302 is covered by an optical coupling 1308. The optical coupling 1308 may include materials such as epoxy resins, silicone oils, silicone rubbers, and/or silicone greases. The optical coupling 1308 is placed in contact with a faceplate 1310 of the photon detector 1306. The faceplate 1310 of the photon detector may be made from, for example, glass. The light generated within the scintillation material 1302 travels through the optical coupling 1308, the faceplate 1310, and into the photon detector 1306.

In illustrative embodiments, the package 1300 also includes a shock absorbing material 1312 that surrounds the reflector 1304 and protects the scintillation material 1302 from excessive shock and vibration. The shock absorbing material 1312 may include RTV silicone, cross-linked polymerizing gel agent dispersed in oil, and/or a similar material that dampens shocks and vibrations. In some embodiments, as shown in FIG. 13, a radiation shielding material 1314 is disposed between the reflector 1304 and the shock absorbing material 1312.

The elpasolite scintillation material 1302, the reflector 1304, and the shock absorbing material 1312 are mounted in a hermetically sealed housing 1316. The housing 1316 is sealed against the photon detector 1306 using, for example, a threaded coupling (e.g., the photon detector includes an external thread and the housing includes an internal thread that receives the external thread). In some embodiments, the housing 1316 is then soldered or welded in place. In various embodiments, an epoxy sealing compound is placed within the threaded coupling.

In some embodiments, a longitudinal end of the scintillation material 1302, that is opposite to the optical coupling 1308, may be in contact with a pressure plate 1318. The pressure plate 1318 is pushed against the end of the scintillation material 1302 by a spring 1320 or similar biasing device. The spring 1320 biases the scintillation material 1302 towards the optical coupling 1308 and the faceplate 1310 of the photon detector 1306. The spring 1320 helps ensure that the scintillation material 1302 remains in optical communication with the photon detector 1306 during (1) vibrations, (2) shocks, and/or (3) thermal expansion of the package due to temperature change. Further details of hermetically sealed packages are provided in U.S. Pat. No. 7,633,058.

The term “processor” should not be construed to limit the embodiments disclosed herein to any particular device type or system. As explained above, the processor may include a computer system. The computer system may include a computer processor (e.g., a microprocessor, microcontroller, digital signal processor, or general purpose computer). The computer system may also include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Any of the methods and processes described above, including processes and methods for (1) processing an output signal that is received from a neutron detector, (2) identifying a peak within the output signal, (3) using pulse shape discrimination to identify the peak, and/or (4) using pulse height discrimination to identify the peak, can be implemented as computer program logic for use with the computer processor.

The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a computer readable medium (e.g., memory) and executed by the computer processor.

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Although several example embodiments have been described in detail above, those skilled in the art will readily appreciate that many modifications are possible in the example embodiments without materially departing from the scope of this disclosure. Accordingly, all such modifications are intended to be included within the scope of this disclosure.

We claim:

1. A borehole logging tool comprising:
a neutron source for releasing source neutrons toward a target formation; and
a scintillator positioned to interact with scattered source neutrons received from the target formation, the scintillator configured to emit luminescence in response to interaction with at least one of thermal and epithermal neutrons, wherein the scintillator comprises an elpasolite material.

2. The borehole logging tool of claim 1, wherein the elpasolite material is represented by Cs₂LiMN₆, wherein M is selected from at least one of Yttrium and Lanthanum and N is selected from at least one of Chlorine and Bromine.

3. The borehole logging tool of claim 2, wherein the elpasolite material is Cs₂LiYCl₆.

4. The borehole logging tool of claim 1, wherein the elpasolite material is represented by LiMN₆, wherein M is selected from at least one of Yttrium and Lanthanum and N is selected from at least one of Chlorine and Bromine.

5. The borehole logging tool of claim 1, wherein the elpasolite is doped with an activator.

6. The borehole logging tool of claim 5, wherein the elpasolite material is doped with cerium.

7. The borehole logging tool of claim 3, wherein the Cs₂LiYCl₆ is doped with cerium.

8. The borehole logging tool of claim 1, further comprising:
a luminescence detector configured to provide an output signal indicative of detected luminescence of the scintillator.

9. The borehole logging tool of claim 8, wherein the scintillator is connected to the luminescence detector by a light guide.

10. The borehole logging tool of claim 1, wherein the elpasolite material is in a polycrystalline form.

11. The borehole logging tool of claim 1, further comprising:
a package for containing the elpasolite material.

12. The borehole logging tool of claim 11, wherein the package is hermetically sealed.

13. The borehole logging tool of claim 8, wherein the scintillator and the luminescence detector are configured to detect at least one of thermal and epithermal neutrons.

14. A method for detecting neutrons, the method comprising:
positioning at least one scintillator comprising an elpasolite material in a well borehole;
releasing neutrons into a formation proximate to a region of the well borehole;
detecting luminescence from the scintillator, wherein the scintillator emits luminescence in response to interaction with neutrons returned from the formation; and
converting luminescence from the scintillator to an electrical signal.

15. The method of claim 14, wherein the elpasolite material is represented by Cs₂LiMN₆, wherein M is selected from at least one of Yttrium and Lanthanum and N is selected from at least one of Chlorine and Bromine.

16. The method of claim 15, wherein the elpasolite material is Cs₂LiYCl₆.

17. The method of claim 14, wherein the elpasolite is doped with an activator.

18. The method of claim 17, wherein the elpasolite material is doped with cerium.

19. The method of claim 14, further comprising:
receiving the electrical signal at a processor; and
using the processor to identify neutron interactions, with the at least one scintillator, based upon pulse shape discrimination.

20. The method of claim 14, wherein the method is performed in borehole temperatures in excess of 50° C.
